(19) United States
(12) Patent Application Publication
(10) Pub. No.: US 2023/0178310 A1
(43) Pub. Date: Jun. 8, 2023

(54) STARTING A VEHICLE MOTOR

(71) Applicant: Ford Global Technologies, LLC, Dearborn, MI (US)

(72) Inventors: Paul Braithwaite, Wanstead (GB); Martin Scheck, Pulheim (DE); James Michael Weinfurther, Farmington, MI (US); Gabriel Dascalu, Chelmsford (GB); Eric L. Reed, Livonia, MI (US)

(21) Appl. No.: 17/545,792

(22) Filed: Dec. 8, 2021

(51) Int. Cl. H01H 13/14; B60K 37/06

(52) U.S. Cl. CPC H01H 13/14; B60K 37/06; H01H 2231/026

(57) ABSTRACT

Apparatus and methods are described for interfacing between a push-button switch assembly for a motor of a vehicle and a starter control device. The push-button switch assembly has plural contacts arranged to close when a driver operates the push-button switch assembly, the interface being arranged to respond to closure of the contacts within a predetermined interval to emit a signal for commanding starting of the motor of the vehicle.

### BACKGROUND

The present disclosure relates to the general field of automotive engineering. Examples of the present disclosure relate to an apparatus for interfacing between a push-button switch assembly for a motor and a starter control device, to a non-transitory computer-readable medium having non-transitory computer-readable instructions encoded thereon for controlling starting of a motor, and to a method of operating a motor.

### SUMMARY

Many vehicles are now being equipped with keyless operation, that is with push-button starter switches (e.g., a push-button switch assembly) for controlling the operation of at least one motor of the vehicle, such as an internal combustion engine and/or an electric motor of the vehicle. In the context of the present disclosure, a vehicle may be any appropriate type of vehicle, such as an automobile, a motorbike, a marine vessel, or an aircraft. In some examples, the vehicle may be any appropriate type of hybrid vehicle, such as a Hybrid Electric Vehicle (HEV), a Plug-in Hybrid Electric Vehicle (PHEV), a Mild Hybrid Electric Vehicle (mHEV), or any other vehicle having an engine and/or an electrified powertrain. In some examples, the systems and methods described herein may be used on or with any machinery or equipment (e.g., a generator) requiring operational control by a user/operator.

Moreover, in the context of the present disclosure, the term “driver” may mean any person who operates or stops a vehicle or any machinery or equipment.

In use with a keyless push-button switch assembly, a user depresses (and releases) the push-button to cause starting of the motor. When it is desired to stop the motor, a user depresses (and releases) the button, and the switch causes the motor to stop.

Starter control systems currently in use may not address the issue of accidental or incorrect interaction, (e.g., depressing and/or releasing) of the push-button switch assembly, or detecting a fault in the push-button switch assembly.

In some examples, there is provided a push-button switch assembly interface for assessing driver intent to start a motor of a vehicle. Additionally or alternatively, there is provided a push-button switch assembly interface for assessing driver intent to stop a motor of a vehicle.

According to examples in accordance with an aspect of the disclosure, there are provided method and systems of operating a motor of a vehicle using an apparatus for interfacing between a push-button switch assembly for a motor and a starter control device. The push-button switch assembly comprises plural contacts arranged to close and open when a user operates the push-button switch assembly. The apparatus is configured to determine a state of closure of each contact of the plural contacts; and in response to determining a second contact of the plural contacts closes within a first predetermined interval (e.g., 10 ms) after closure of a first contact of the plural contacts, emit a command to start the motor.

In some examples, the apparatus is configured to emit the command to start the motor in response to determining the first contact of the plural contacts opens within a second predetermined interval (e.g., 40 ms) after closing of the first contact of the plural contacts.

In some examples, the apparatus is configured to emit the command to start the motor in response to determining the second contact of the plural contacts opens within a third predetermined interval (e.g., 40 ms) after closing of the second contact of the plural contacts.

In some examples, the apparatus is configured to determine an interaction period defining the duration for which the user operates the push-button switch assembly, e.g., from a database of user interaction periods; determine that each of the plural contacts are open at the end of the interaction period; and emit the command to start the motor in response to determining that each of the plural contacts are open at the end of the interaction period.

In some examples, the apparatus is configured to initiate a fault detection cycle in response to determining the closure of the first contact of the plural contacts; determine that the first contact of the plural contacts opens within the second predetermined interval after the closing of the first contact of the plural contacts; output a fault confirmation signal in response to determining that the second contact of the plural contacts does not close within the second predetermined interval after closure of a first contact of the plural contacts.

In some examples, the apparatus is configured to request an alternative starting procedure to be undertaken so as to emit the signal for commanding starting of the motor in response to: determining that the second contact of the plural contacts does not close within the first predetermined interval after closure of the first contact of the plural contacts; determining that the first contact of the plural contacts does not open within the second predetermined interval after closing of the first contact of the plural contacts; determining that the second contact of the plural contacts does not open within the third predetermined interval after closing of the second contact of the plural contacts; and/or determining that at least one of the plural contacts is closed at the end of an interaction period defining the duration for which the user operates the push-button switch assembly.

According to examples in accordance with an aspect of the disclosure, there is provided a method of operating a motor of a vehicle, the method comprising receiving respective inputs from each of plural switch elements of a starter switch (e.g., push-button switch assembly), detecting the time between two of the inputs and providing a start command at an output in response to the detected time period being less than a predetermined amount.

The method may further comprise responding to a detected time period greater than the predetermined amount by causing a predetermined message to be output.

The method may comprise responding to a detected time period greater than the predetermined amount by blocking the provision of the start signal until an alternative starting procedure is implemented.

In some aspects, there is provided an apparatus for interfacing between a push-button switch assembly for a motor of a vehicle and a starter control device, the push-button switch assembly having plural contacts arranged to close when a driver operates the push-button switch assembly, the interface being arranged to respond to closure of the contacts within a predetermined interval to emit a signal for commanding starting of the motor of the vehicle.

The apparatus may be arranged to detect contact closure, and if a second contact is not detected as closing within the predetermined interval after detecting closure of a first contact, to require an alternative starting procedure to be undertaken so as to emit the signal for commanding starting of the motor of the vehicle.

The apparatus may be configured to cause display of a message instructing a driver to use the alternative starting procedure.

The alternative starting procedure may comprise operating push-button switch assembly twice within a given time period, such as 2 seconds.

The predetermined interval may be a time under 100 mS.

The predetermined interval may be 40 mS.

The apparatus may be arranged to detect electrical failures such as open circuit and/or short circuit.

The apparatus may be arranged to detect one or more stuck contacts of the starting switch.

The apparatus may be arranged to detect intermittent fault conditions.

In some aspects, there is provided a control device for controlling starting of a motor, the control device having plural start inputs for receiving respective inputs from a starter switch and an output for a start signal, the processing circuitry having storage circuitry and processing circuitry, the processing circuitry being configurable to run a program under control of a set of instructions in the processing circuitry, the program causing monitoring respective start inputs, detecting a time period between two of the start inputs and providing a signal at said output if the detected time period is less than a predetermined amount.

In some aspects there is provided a non-transitory computer-readable medium having non-transitory computer-readable instructions encoded thereon for controlling starting of a motor, when executed by control circuitry to cause the control circuitry to perform the step of: responding to closure of contacts of a vehicle starter switch within a predetermined interval after a foregoing contact closure to emit a signal for commanding starting of the motor.

There is also provided a pushbutton switch and control system for processing commands for motor on, for accessory, and for motor off commands from a driver. Monitoring circuits may provide switch debounce and enable fault detection.

It is desirable to have confidence that a driver really intended to initiate a start. It is desirable that a vehicle powers down when the driver requests stopping of the motor.

### BRIEF DESCRIPTION OF THE DRAWINGS

The above and other objects and advantages of the disclosure will be apparent upon consideration of the following detailed description, taken in conjunction with the accompanying drawings, in which:

FIG. 1 shows an exemplary push-button switch assembly in an exploded view;

FIG. 2A illustrates a detailed view of an end cover and a keypad of the push-button switch assembly of FIG. 1;

FIG. 2B illustrates a detailed view of a keypad of the push-button switch assembly of FIG. 1;

FIG. 2C illustrates a detailed view of an end cover and a circuit board of the push-button switch assembly of FIG. 1;

FIG. 3 illustrates a schematic view of push-button switch connected electrically to a body control module;

FIG. 4 illustrates a schematic view of another push-button switch;

FIG. 5 illustrates the context of the starter system;

FIG. 6 illustrates an outline view of a vehicle;

FIG. 7 illustrates a body control module;

FIG. 8 depicts various waveforms resultant from a user operating the push-button switch assembly;

FIG. 9 depicts various waveforms resultant from a user operating the push-button switch assembly;

FIG. 10 depicts various waveforms resultant from a user operating the push-button switch assembly;

FIG. 11 depicts various waveforms resultant from a user operating the push-button switch assembly;

FIG. 12 depicts various waveforms resultant from a user operating the push-button switch assembly.

The figures herein depict various examples of the disclosed disclosure for purposes of illustration only. It shall be appreciated that additional or alternative structures, systems and methods may be implemented within the principles set out by the present disclosure.

### DETAILED DESCRIPTION

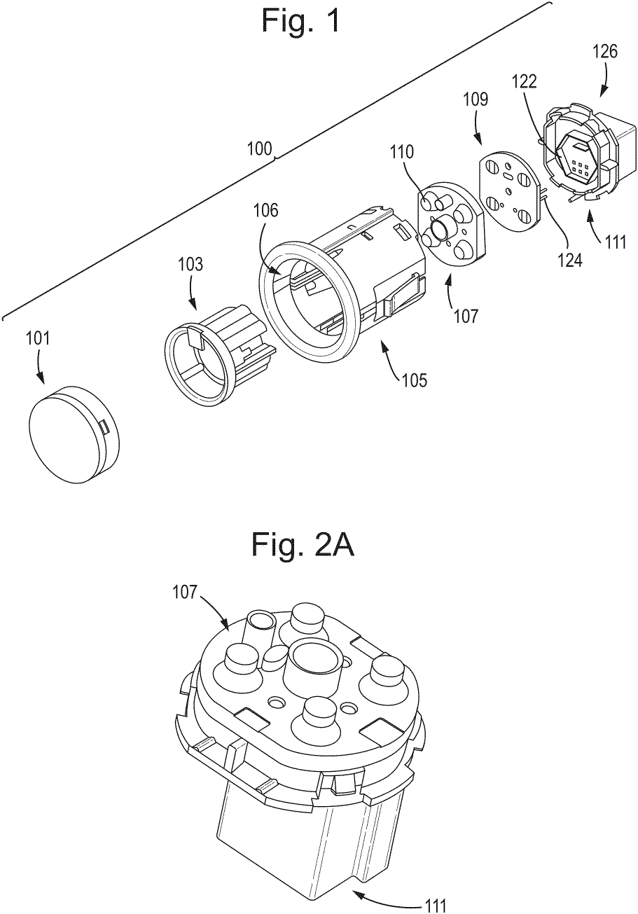

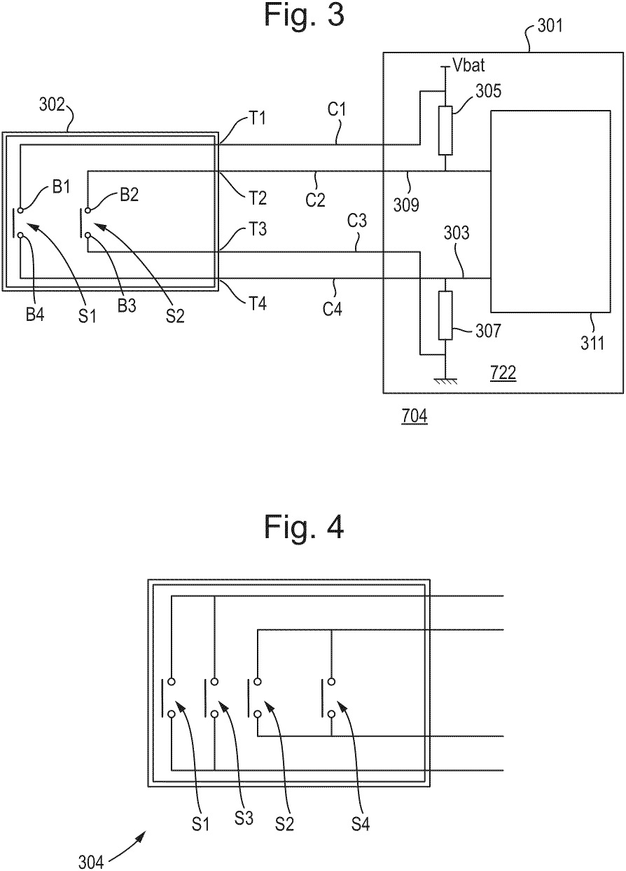

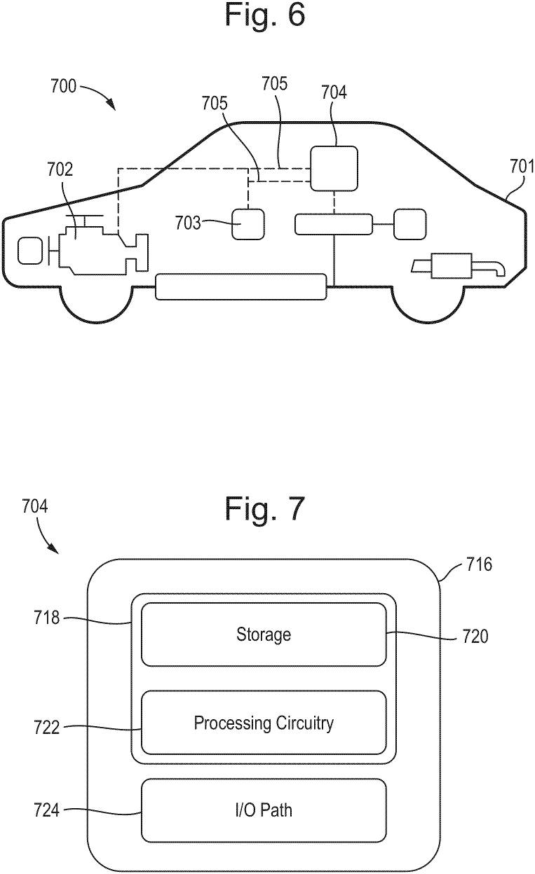

Referring first to FIG. 6, a vehicle 700 (e.g., a car) has a body 701 housing a motor 702, shown at the front of the vehicle 700. Within the body of the vehicle 700 there is a push-button switch assembly 703 (e.g., the push-button switch assembly 100 as described below with reference to FIGS. 1 to 4) and a controller 704 (e.g., Body Control Module (BCM) 301 as described below with reference to FIG. 3). The push-button switch assembly 703 is connected via a wiring loom 705 to the controller 704. The controller 704 is connected to the motor 702 also via the wiring loom 705. The controller 704 may be operationally coupled to a push-button switch assembly 703 to cause the motor 802 of the vehicle 800 to be started or stopped upon operation of the push-button switch assembly 100 803 by a user.

FIG. 7 illustrates the controller 704 of FIG. 6 in more detail. In particular, controller 704 has a substrate 718 (e.g., control circuitry) and an I/O path 724. The substrate 718 carries storage circuitry 726 and processing circuitry 722. The storage circuitry 720 may be at least partly non-volatile. The storage circuitry 720 contains program data for instructing the processing circuitry 722 to run one or more programs that process incoming signals from the I/O path 724 and provide output signals via the I/O path 724. The output signals are mainly interpreted by the circuitry that receives them as commands.

In the present context, incoming signals include those from the starter switch (see e.g., FIG. 3) and output commands include those destined for starter motor operating circuitry.

The presently described example is of a digital type but the invention is equally applicable to analog examples, in addition or as an alternative.

Referring to FIG. 1, an exemplary push-button switch assembly 100 having a push-button 101 that is engaged with or held by a slider 103 which is housed in a switch body or housing 105. The housing 105 is a generally circular-cylindrical body defining an internal passageway 106 within which the slider 103 is moveably disposed. The push-button 101 is arranged to be able to be urged into the housing 105 whereby the slider 103 is entrained to move into the housing 105.

Continuing to refer to FIG. 1, the push-button switch assembly further has a flexible keypad 107, a printed circuit board 109 and an end cover 111. In this currently described example, printed circuit board 109 and flexible keypad 107 define four switch elements. However fewer or larger numbers of switch elements are envisaged.

In some examples, the push-button 101 and the slider 103 may be formed as a single piece. However, it is understood that, irrespective of the exact configuration of the push-button 101 and the slider 103, the push-button 101 and the slider 103 are moveable in the housing 105 (e.g., upon application of a push force on an operational surface of the push-button 101) to cause an end of the slider 103 to deform the flexible keypad 107. In some examples, the push-button switch assembly 100 comprises a biasing means configured to act against a push force of a user and return the push-button 101 and the slider 103 back to its initial position prior to user operation. Additionally or alternatively, flexible keypad 107 comprises one or more resilient portions 110 configured to deform upon engagement by and axial displacement of the end of the slider 103, and provide a biasing force acting to return the push-button 101 and the slider 103 back to its initial position (e.g., following release of the push-button 101 by a user). Flexible keypad 107 is mounted against (or near to) circuit board 109, the detail of which is discussed below. Circuit board 109 sits in end cover 111, which is retained in housing 105 by one or more fasteners (e.g., clips). The end cover 111 comprises one or more openings 122 through which respective electrical contacts, e.g., pins 124, of the circuit board 109 extend in an assembled configuration. The end cover 111 comprises a connector port 126, configured to receive and secure an electrical connector (not shown) to a rear end of the push-button switch assembly 100, the electrical connector being configured to connect to the pins 124 of the circuit board 109 (e.g., so that electrical power may be supplied to the push-button switch assembly 100 and/or one or more operational parameters of the push-button switch assembly 100 may be measured).

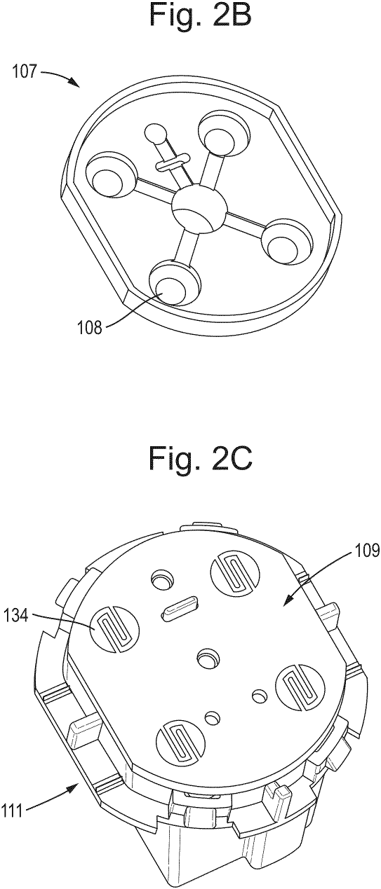

FIG. 2A illustrates a partly assembled push-button switch assembly (100) with the flexible keypad 107 mounted on the end cover 111 and sandwiching the printed circuit board 109 (hidden in this drawing) between the flexible keypad 107 and the end cover 111.

FIG. 2B illustrates the keypad 107 in an inverted view. The keypad 107 comprises one or more electrical contacts 108, each of which are provided on an underside of respective deformable portions (e.g., resilient portions 110 as described above with reference to FIG. 1). When the keypad 107 is in a relaxed state, e.g., when the push-button switch assembly 100 is in its initial position, each electrical contact 108 is separated from the face of circuit board 109. When the keypad 107 is in a deformed state, e.g., upon displacement of push-button 101 and slider 103 in housing 105, each electrical contact 108 is urged towards the face of circuit board 109 to cause contact between each electrical contact 108 and respective switch contacts 134 of circuit board 110. In this manner, displacement of the push-button 101 and the and slider 103 in housing 105 causes at least one electrical circuit of circuit board 109 to be closed by virtue of engagement of electrical contact 108 with switch contact 134.

FIG. 2C illustrates a printed circuit board 109 overlaying onto the end plate 111. The circuit board 109 comprises four switch contacts 134 (e.g., gold-plated mesh contacts) that are each closable by respective electrical contacts 108 of the keypad 107. In the context of the present disclosure, it is understood that each electrical contact-switch contact pair make up a switch of the push-button switch assembly 100. Details of the electrical circuits of circuit board 109 are discussed below in relation to FIGS. 3 and 4.

In use a driver operates the push-button 101, pressing it inwardly of the housing 105. The push-button 101 is secured to the slider 103 which is urged by the pressure on the push-button 101 to engage with the flexible keypad 107. The pressure applied to the flexible keypad 107 causes the contacts 108 of the flexible keypad 107 to electrically engage with the switch contacts 134 and complete the electric circuit. After pressing the push-button 101, it is released, and the flexible keypad 107 urges the slider 103 and push-button 101 back to an initial position.

However, force exerted on the push-button 101 may not be centrally applied to the push-button 101 either because of an intentional operation of the push-button 101 that is sloppily carried out, or because the push-button 101 is unintentionally operated (e.g., accidentally knocked sufficiently to cause the contacts to engage when not desired to do so). Alternatively, the force may be very slight, giving rise to overly slow operation of the push-button 101.

The present example is configured to sense the operation of the push-button switch assembly 100 elements to assess the likelihood that a driver wants to start the motor. The likelihood is determined by detecting the time between reception of signals indicative of, and caused by, operation of the push-button switch assembly 100 elements.

Referring to the schematic diagram of FIG. 3, a push-button switch assembly 302 (e.g., push-button switch assembly 100 as described above with reference to FIG. 1) is connected electrically to a controller (e.g., controller 704 as described above with reference to FIGS. 6 and 7). This controller may comprise a BCM (body control module) 301. Only a part of the BCM 301 is shown, for simplicity.

The BCM 301 is a control module which may control parts and components of the vehicle that are generally not directly part of the motor and transmission. In the described example, the BCM 301 has a function that emits commands to initiate starter motor cranking on the one hand and to effect stopping of rotation of the motor. Other functions may be effected by the BCM 301, for example lighting, screen washing and wiping.

As noted above, the controller 704 comprises a processor 722 and storage elements 720 for storing and running programs that cause the controller 704 to provide its functions. Parts of the programs may comprise motor start and/or motor stop control as recited below.

The example of the push-button switch assembly 302 that is shown in FIG. 3 has first and second switch elements S1 and S2 that are each single pole, single throw, normally open switches. In the example of FIGS. 1 and 2, four switch elements are provided (see also FIG. 4). A push-button (e.g., push-button 101 as described above with reference to FIG. 1) is secured in movable fashion with regard to the contacts of the two switch elements S1 and S2, so that when the push-button 101 is urged towards the contacts of the switch elements, the contacts become closed.

Referring to FIG. 4, an alternative push-button switch assembly 304 is described, which is similar to push-button switch assembly 302 shown in FIG. 3, save that each switch element S1, S2 has a respective parallel switch element S3, S4. Operation is unchanged but the additional parallel switch elements afford redundancy.

As mentioned above, the invention can be applicable to analog examples. In such examples push-button switch assembly 304 of FIG. 4 may further comprise a first resistor R1 arranged in series with S1 and S3, and a second resistor R2 arranged in parallel with R1 and S1/S3. R1 may have a resistance of 470 Ω and a tolerance of 1%, and R2 may have a resistance of 4.7kΩ and a tolerance of 1%. The push-button switch assembly 304 may further comprise a third resistor R3 arranged in series with S2 and S4, and a fourth resistor R4 arranged in parallel with R3 and S2/4. R3 may have a resistance of 300 Ω and a tolerance of 1%, and R4 may have a resistance of 3kΩ and a tolerance of 1%. It is understood that the resistance and tolerance values stated herein are used by way of example, and are not intended to limit the scope of the disclosure.

In some examples, push-button switch assembly 304 may be coupled to controller 704 in a similar manner as push-button switch assembly 302. Processing circuitry 722 of the controller may comprise analog to digital converters (ADCs) configurable to perform an ADC count on measured voltages across various stages of the circuit.

Returning to FIG. 3, the controller 704 has 4 conductors C1, C2, C3 and C4, respectively, each directly connecting the controller 704 electrically with four terminals of the push-button switch assembly 302.

The push-button switch assembly 302 has internal electrical connections B1-4 connecting the switch elements S1 and S2 to four terminals T1-4 shown here illustratively on a rearward face of the push-button switch assembly 302.

The first switch S1 has a first electrical connection B1 connected to terminal T1 and then to conductor C1 and a second electrical connection B4 connected to terminal T4 and then to conductor C4. The second switch element S2 has a first electrical connection B2 connected to terminal T2 and then to conductor C2 and a second electrical connection B3 connected to terminal T3 and then to conductor C3.

In use, conductor C1 is supplied from the controller 704 with battery voltage Vbat, typically but not exclusively, 12 volts, and connects this via terminal T1 to a pole of first switch element S1 via first electrical connection B1. The other pole of first switch S1 connects via second electrical connection B4, terminal T4 and conductor C4 to a first input 303 of the controller 704. The input 303 may have an associated pull-down resistor 307, for pulling the first input 303 down to the ground in the absence of a signal from the push-button switch assembly 302.

Conductor C3 is connected to ground from the controller 704 and connects this via terminal T3 to a pole of second switch element S2 via first electrical connection B3. The other pole of first switch element S2 connects via second electrical connection B2, terminal T2 and conductor C2 to a second input 309 of the controller 704. This input 309 may have a pull-up resistor 305 for pulling the input 309 up to the battery voltage Vbat in the absence of a signal from the push-button switch assembly 302.

When switch element S1 closes it can feed Vbat from controller 704 to the first input 303 of the controller 704 which overcomes the pull-down resistor 307 to provide a positive-going input pulse edge. When switch element S2 closes it can feed 0v from controller 704 to the second input 309 of the controller 704 which overcomes the pull-up resistor 305 to provide a negative-going input pulse edge.

There are envisaged two types of starting operation: a correct starting operation and one or more incorrect starting operations. In a correct starting operation, the user depresses the push-button switch assembly 302 and releases it. Upon pressing push-button switch assembly 302, both switching elements S1 and S2 close substantially simultaneously, that is within a predetermined time period, say within 10 mS, of one another. Upon releasing the push-button switch assembly 302, both switching elements S1 and S2 open substantially simultaneously, that is within a predetermined time period, say within 10 mS, of one another.

In an incorrect starting operation both switching elements S1 and S2 may not close within the predetermined time period. The cause of the incorrect starting operation may be due to a number of issues, including inadequate pressure on the push-button, too slow pressing (and/or release) of the push-button, and a fault, for example in the starter switch. Such a fault may be caused, without limitation, by for example, dirt on switch contacts, spillage of a fluid such as a drink on the starter switch, etc.

In a correct starting operation, a driver uses the push-button switch assembly 302 to start the vehicle motor, by urging the push-button inwardly of the body of the switch such that both switch elements S1 and S2 operate simultaneously or near simultaneously. This action provides pulses from the closure of switch elements S1 and S2.

Because in a correct starting operation the switch S1 and switch S2 operate substantially simultaneously, the pulses occur at the controller 704 substantially simultaneously. As a result, the programming of the controller 704 causes it to recognize that the starter motor should be caused to rotate in order to start the vehicle, and/or power should be supplied to an electric motor of the vehicle to cause the electric motor to start. Provided that specified other conditions are correct (as sensed by sensors of the vehicle) the controller 704 commands the starter motor to rotate and the motor will be thereby rotated.

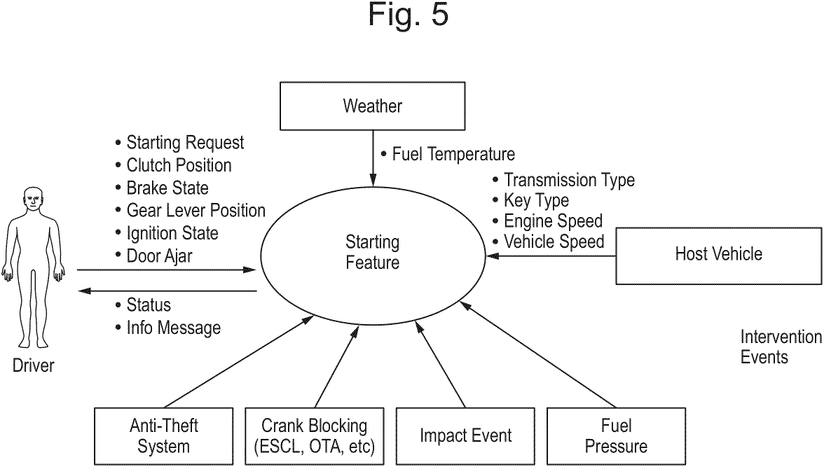

Such other conditions are well known by those skilled in the art, and may include conditions shown by way of example 500, in FIG. 5. In this drawing the examples include clutch position, brake state, gear lever position, and ignition state. Different conditions will apply to different vehicle types, for example automatic transmission vehicles.

Turning now to an incorrect starting operation, the correct starting operation may be prevented from occurring by a fault or by the starter switch not being correctly operated (e.g., by unintentional contact with the push-button). Then, although one switch S1 or S2 does close, the other switch S2 or S1 does not close within a predetermined time period, or does not close at all. Further, upon release of the push-button, although one switch S1 or S2 does open, the other switch S2 or S 1 does not open within a predetermined time period, or does not open at all.

In this case, the controller 704 does not respond by enabling starring of the motor, but instead it is programmed to cause display to the driver of a message inviting an alternative starting procedure to be used. One alternative starting procedure, for example, involves inviting the driver to operate the push-button switch assembly 302 twice within a short period of time, for example 5 seconds. This message is only displayed temporarily by the controller 704, for example for 20 seconds. In this example the message is displayed in the instrument cluster, although other arrangements are possible.

When, after the fault has been recognised, the driver wishes to start the vehicle motor, he must use the above-described alternative starting procedure. So long as he does so, the controller 704 is programmed to respond by commanding starting of the starter motor.

However, other examples are arranged to allow for fault healing; in such examples a subsequent attempt to start using the “normal” starting procedure may be successful if the fault has healed, thereby removing or resetting any fault code that had been created after use of the emergency starting procedure, or had been created by sensing a fault. A purely illustrative example of healing is where switch contacts stick due to a fluid spill, but after a time has elapsed the fluid dries and normal operation then occurs.

It will be seen from the above description that where there is no relevant fault, the controller 704 effectively carries out a plausibility check to determine a “likely intention to start” condition, and to provide instructions for an alternative sequence where the check has a negative result. Where there is a fault, the controller 704 records the fault and provides the alternative sequence so that a driver should not be left stranded.

To stop the motor, the driver operates the push-button switch assembly 302, e.g., by again pressing (and releasing) the push-button switch assembly 302. The controller 704 may be programmed to cause the motor to stop in response to a single pulse for the operation of one of the switches S1 and S2.

The present example takes into account the fact that one of the switches S 1 and S2 may fail in use so that pressing the push-button switch assembly 302 could result in a fault condition, with only one of the two switches S1 and S2 closing under pressing of the press button. If inputs from both switches were required in order to stop the motor, this single failure could cause a problem if the motor could not be stopped.

Accordingly, the controller 704 may be programmed to respond to only one received switch pulse to stop the motor.

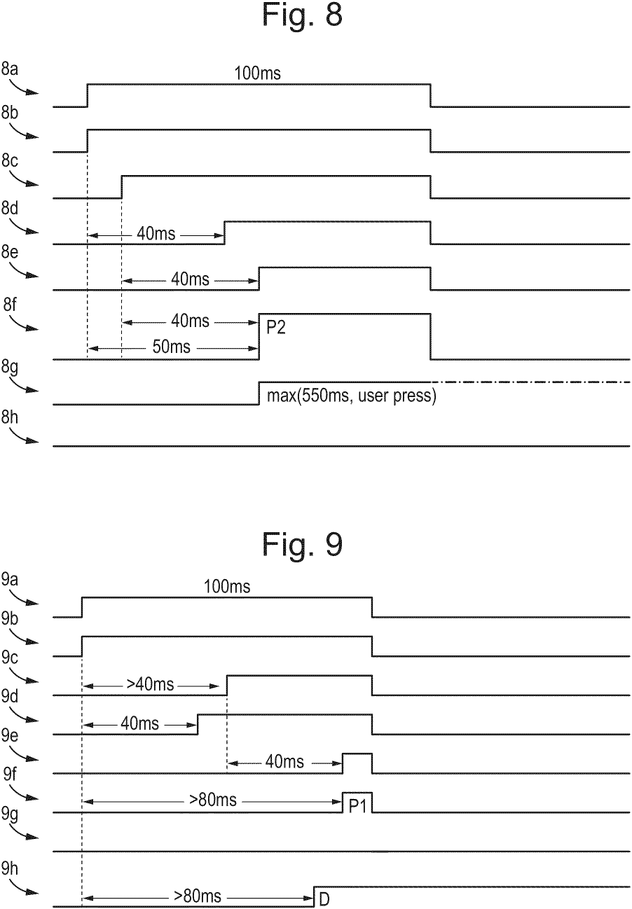

Turing to FIG. 8, the top waveform 8a shows the overall interaction of a user operating the push-button switch assembly 302 with pressing and releasing the push-button switch taking at least 100 mS. 100 mS is an arbitrary period and is selected as being less than the likely minimum duration of a “push-release” sequence. That is to say, any likely sequence will be at least 100 mS. The second waveform 8b shows the initial closure of S1 in response to the operation of the push-button switch assembly 302.

It is assumed that one of the two switches will respond slightly after the other. A slightly delayed response from S2 is shown as waveform 8c, in this case arbitrarily chosen to be 10 mS later than waveform 8b.

A short interval after the driver presses the button, the driver releases it. As, such, waveforms 8d and 8e are debounced versions of waveforms 8b and 8c with the debouncing period (the period during which noise abates) in this example being 40 mS.

Waveform 8f shows an output start pulse P2 which is the result of logical AND-function of waveforms 8d and 8e. This pulse P2 is generated if logic circuitry (not shown) indicates that both switches have been closed within a predetermined time interval (in this example 40 mS) from the closure instant of the first switch S1 to close, and switches S1 and S2 have been opened within a predetermined time interval (in this example 40 mS) from the closure instant of each respective switch. The output start pulse P2 is passed to the CAN (controller area network) as waveform 8 g for starting the motor.

Waveform 8f state is decided only after both debounced contacts have closed but no later than 40 ms from when the first contact is debounced closed. During this 40 ms delay the waveform 8f remains unchanged. If second contact is detected as “Pressed” during this 40 ms “P2” is immediately reported otherwise at the end of the 40 ms “P1” (indicating that only one of the switches has been closed by the pressing action) is reported.

550 mS may be the minimum duration of the CAN signal, so a 100 ms or slightly longer press sends a 550 mS signal, a longer press than 550 mS elongates the CAN signal accordingly. This is to allow modules to wake and see a press message.

The final waveform is a fault waveform on line 8h. In this case there is no plausibility or other fault so no fault pulse appears on 8h.

FIG. 9 shows a situation where the contacts of S1 and S2 close more than 40 mS from each other (or alternatively where the second closure of the contact does not take place at all). Waveform 9a shows the interaction of the user pressing and releasing the push-button switch assembly 302 with the time between the pressing and releasing the push-button switch assembly 302 again being 100 mS. Waveform 9b shows the initial closure of S1 in response to the operation of the push-button switch assembly 302. In this case, the closure of S2 is delayed compared to the example of FIG. 8, with the S2 switch closure (waveform 9c) occurring more than 40 mS after the response of the first switch closure (waveform 9b).

The debounced first switch closure (waveform 9d) occurs 40 mS after the switch press action of the user whereas the debounced second switch closure (waveform 9e) in the one case occurs more than 40 mS from the debounced first switch closure, and in the other case (e.g., in the event of a switch fault in which the switch is stuck in the open position) does not occur at all. In the first case a second output pulse P1 is output.

In this case, logic circuitry in the controller recognizes the fact that there is no debounced waveform 9e within 40 mS of the debounced first switch closure shown in waveform 9d. Accordingly, the logic circuitry provides a plausibility fault pulse waveform 9h that prevents output of a start signal to the CAN.

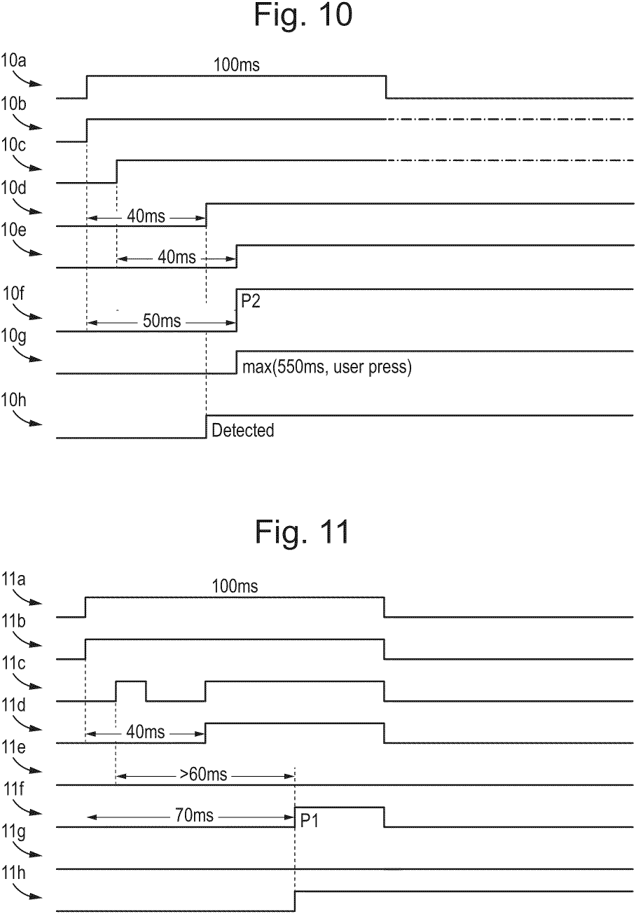

FIG. 10 shows a case in which the push-button switch has become stuck. In this specific case, the contacts of the push-button switch close in less than 40 mS from each other but both stay closed. As shown in the specific example of FIG. 10 the debounced switch closures take place within 40 mS of each other. The output start pulse, waveform 10f, once again responds to logical AND operation on the debounced switch closures.

A detection of a stuck state is initiated when the push-button is pressed and from that point a period, e.g., 120s is counted. If the state remains set to detected for that 120s then it becomes changed it to “Fault” - which means a genuine stuck button as nobody would hold it pressed for so long. The specific time of 120s is not essential to the invention, the requirement being a time period greater than any likely intentional press.

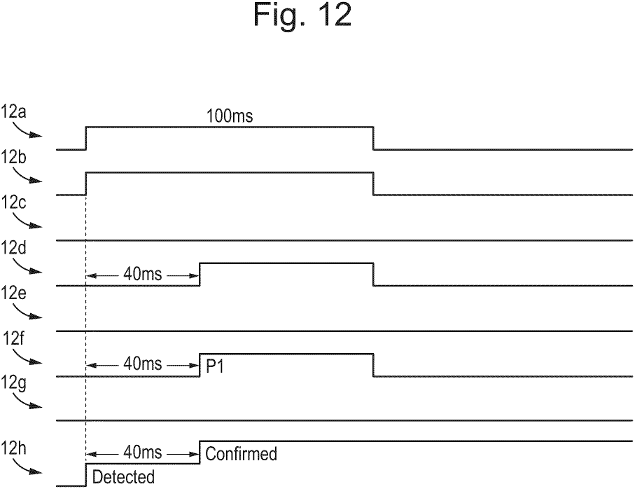

FIG. 11 shows a situation where one set of contacts behaves erratically. For example, as shown in the figure at waveform 11c, the contact briefly closes, then opens again, then closes and stays closed. The controlling logic is set to monitor stabilisation of the inputs to be within 60 mS of initial operation. In the present drawing, stabilisation does not take place until 70 mS has elapsed after initial switch operation and accordingly a fault condition is recognized. This prevents output to the CAN and accordingly no start command is issued.

FIG. 12 shows a situation where at least one of the switch contacts of the push-button switch assembly 302 has an electrical failure. Such failures include open circuit, short circuit to ground and short circuit to battery voltage. The logic (see waveform 12h) is set to initiate assessment of the probability of a fault upon initial operation of the push-button switch assembly 302 and to confirm the fault after a 40 mS debounce period of one of the switch contacts inputs.

This disclosure is made for the purpose of illustrating the general principles of the systems and processes discussed above and are intended to be illustrative rather than limiting. More generally, the above description is meant to be exemplary and not limiting and the scope of the disclosure is best determined by reference to the appended claims. In other words, only the claims that follow are meant to set bounds as to what the present disclosure includes.

While the present disclosure is described with reference to particular example applications, it will be appreciated that the disclosure is not limited hereto and that particular combinations of the various features described and defined in any aspects can be implemented and/or supplied and/or used independently. It will be apparent to those skilled in the art that various modifications and improvements may be made without departing from the scope and spirit of the present disclosure. Those skilled in the art would appreciate that the actions of the processes discussed herein may be omitted, modified, combined, and/or rearranged, and any additional actions may be performed without departing from the scope of the disclosure.

Any system features as described herein may also be provided as a method feature and vice versa. As used herein, means plus function features may be expressed alternatively in terms of their corresponding structure. It shall be further appreciated that the systems and/or methods described above may be applied to, or used in accordance with, other systems and/or methods.

Any feature in one example and/or aspect may be applied to other examples and/or aspects, in any appropriate combination. In particular, method examples and/or aspects may be applied to system examples and/or aspects, and vice versa. Furthermore, any, some and/or all features in one example and/or aspect can be applied to any, some and/or all features in any other example and/or aspect, in any appropriate combination.

What is claimed is:

1. An apparatus for interfacing between a push-button switch assembly for a motor and a starter control device, the push-button switch assembly comprising plural contacts arranged to close and open when a user operates the push-button switch assembly, the apparatus being configured to:
determine a state of closure of each contact of the plural contacts; and
in response to determining a second contact of the plural contacts closes within a first predetermined interval after closure of a first contact of the plural contacts, emit a command to start the motor.

2. The apparatus of claim 1, wherein the apparatus is configured to:
emit the command to start the motor in response to determining the first contact of the plural contacts opens within a second predetermined interval after closing of the first contact of the plural contacts.

3. The apparatus of claim 1, wherein the apparatus is configured to:
emit the command to start the motor in response to determining the second contact of the plural contacts opens within a third predetermined interval after closing of the second contact of the plural contacts.

4. The apparatus of claim 1, wherein the apparatus is configured to:
determine an interaction period defining the duration for which the user operates the push-button switch assembly;
determine that each of the plural contacts are open at the end of the interaction period; and
emit the command to start the motor in response to determining that each of the plural contacts are open at the end of the interaction period.

5. The apparatus of claim 1, wherein the apparatus is configured to:
initiate a fault detection cycle in response to determining the closure of the first contact of the plural contacts;
determine that the first contact of the plural contacts opens within a second predetermined interval after the closing of the first contact of the plural contacts;
output a fault confirmation signal in response to determining that the second contact of the plural contacts does not close within the second predetermined interval after closure of a first contact of the plural contacts.

6. The apparatus of claim 1, wherein the apparatus is configured to:
request an alternative starting procedure to be undertaken so as to emit the signal for commanding starting of the motor in response to at least one of:
determining that the second contact of the plural contacts does not close within the first predetermined interval after closure of the first contact of the plural contacts;
determining that the first contact of the plural contacts does not open within the second predetermined interval after closing of the first contact of the plural contacts;
determining that the second contact of the plural contacts does not open within the third predetermined interval after closing of the second contact of the plural contacts; or
determining that at least one of the plural contacts is closed at the end of an interaction period defining the duration for which the user operates the push-button switch assembly.

7. The apparatus of claim 1, arranged to cause emission of a message to instruct a user to use the alternative starting procedure.

8. The apparatus of claim 1, wherein the alternative starting procedure comprises operating the push-button switch assembly twice within a given time period.

9. A vehicle comprising the apparatus of claim 1.

10. A non-transitory computer-readable medium having non-transitory computer-readable instructions encoded thereon for controlling starting of a motor, which when executed by control circuitry causes the control circuitry to perform the steps of:
determining a state of closure of each contact of plural contacts of a push-button switch assembly; and
in response to determining a second contact of the plural contacts closes within a first predetermined interval after closure of a first contact of the plural contacts, emitting a command to start a motor.

11. A method of operating a motor, the method comprising:
determining a state of closure of each contact of plural contacts of a push-button switch assembly; and
in response to determining a second contact of the plural contacts closes within a first predetermined interval after closure of a first contact of the plural contacts, emitting a command to start a motor.
